(19) United States
(12) Patent Application Publication
(10) Pub. No.: US 2014/0118288 A1
(43) Pub. Date: May 1, 2014

(54) MECHANICAL STRUCTURE FOR SYSTEM USING FLUSH SURFACE DISPLAY DESIGN

(71) Applicant: LENOVO (SINGAPORE) PTE, LTD, New Tech Park (SG)

(72) Inventors: RYOHTA NOMURA, YAMATO-SHI (JP); KE SHANG, BEIJING (CN)

(73) Assignee: LENOVO (SINGAPORE) PTE, LTD, NEW TECH PARK (SG)

(21) Appl. No.: 13/663,356

(22) Filed: Oct. 29, 2012

(51) Int. Cl. G02F 1/1335; G06F 3/044

(52) U.S. Cl. 345/174; 349/96; 349/58

(57) ABSTRACT

A display device may provide a seamless appearance adjacent the edges of a display. The display device may include a protective transparent layer and a polarizer coupled to an interior side of the transparent layer. The polarizer layer may include edges that extend as far as edges of the transparent protective layer. In some embodiments, the transparent protective layer may extend to the edges of a supporting housing. An electronic display unit may be disposed on a side of the polarizer layer that is opposite the transparent protective layer.

### BACKGROUND OF THE INVENTION

The present invention relates generally to electronic displays and, more specifically, to a mechanical structure for a system using flush surface display design.

Electronic devices, including portable electronic devices, have gained widespread use and may provide a variety of functions including, for example, telephonic, electronic messaging and other personal information manager application functions. Portable electronic devices include, for example, several types of mobile stations, such as simple cellular telephones, smart phones, wireless personal digital assistants (PDAs), tablets, and laptop computers with wireless or Bluetooth® capabilities.

Users increasingly demand electronic devices with additional capabilities and physical configurations, such as crisp displays, touch-sensitive input devices, and unbroken flat surfaces. Users also demand these capabilities and configurations in ever smaller form factors (that is, an overall size of the device). For example, flush surface designs are becoming popular in display mechanical structures. In a typical flush surface design, a display area and its trim may be fully covered by a transparent protective layer. Typically, there is no mechanical bump on the display side of the device so that the transparent protective layer provides a smooth surface extending from one edge to an opposite edge of the device. Users may thus run their finger smoothly along the flush surface over the display screen. Flush surfaces may be employed for example, in devices incorporating touch screen technology where the lack of mechanical bumps may be suitable for example with capacitive sensors. In another sense, flush designs may also be popular because of their aesthetic appearance which some may consider streamlined or futuristic.

As shown in FIG. 1A, a conventional laptop PC 100 may have a display 102 including a flush surface design. The display 102, with its flush surface design that excludes a mechanical bump between a trim 104 and the display active area, may have the trim 104 extending inward from the display perimeter into the display area. The trim 104 may be a film attached to an underside of the display 102 hiding some of the internal components of the display 102 from view however may be visible itself. In some cases including a flush surface design, the trim 104 may be a different shade than the display area creating an apparent inconsistency in the appearance of the display 102.

Therefore, it can be seen that a display device that can provide a uniform appearance in the display area may be desirable.

### SUMMARY

In one aspect, a display device comprises a glass layer including a first side and a second side, wherein the first side is exposed to an external side of the display device; a capacitive sensing layer attached to the second side of the glass layer; a polarizer layer coupled to a side of the capacitive sensing layer opposite the second side of the glass layer, wherein the polarizer layer includes a width and length that correspond to a width and length of the glass layer; an electronic display unit coupled to the polarizer layer; and a light source coupled to the electronic display unit.

In another aspect, a computing system comprises a housing; a computing device coupled to the housing; and a display device in operable connection with the computing device, wherein the display device comprises: a transparent protective layer coupled to the housing; a polarizer layer disposed between the transparent protective layer and the housing, wherein the polarizer layer includes a width that corresponds to a width of the transparent protective layer; an electronic display unit coupled to the polarizer layer, wherein the electronic display unit is controlled by the computing device, and a light source coupled to the electronic display unit.

In a further aspect, a liquid crystal display comprises a transparent protective layer; a color filter disposed on an interior side of the transparent protective layer, wherein the color filter is configured for control by a computing device; a first polarizer layer disposed between the transparent protective layer and the color filter, wherein edges of the polarizer layer extend to edges of the transparent protective layer; and a backlight source disposed to illuminate the color filter.

These and other features, aspects and advantages of the present invention will become better understood with reference to the following drawings, description and claims.

### BRIEF DESCRIPTION OF THE DRAWINGS

FIG. 1A is a perspective view of a conventional laptop computer;

FIG. 1B is a perspective view of a laptop computer incorporating a display device without a visible trim according to an exemplary embodiment of the present invention;

FIG. 2 is a detailed exploded view of the display device of FIG. 1B according to another exemplary embodiment; and

FIG. 3 is a cross-sectional view of a display device according to another exemplary embodiment of the present invention.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments may provide a display device with a display area that may be flush to the perimeter of the display. The display device may be used for various models or designs of electronic devices, such as a notebook PC, a smart phone, a cell phone, and a personal digital assistant (PDA), an ATM, a printer, a game console, a GPS system, or any other device having a touch sensitive screen, for example. Also, while the application of a transparent conductive layer to a polarizer is described in the context of providing touch screen functionality, it will be understood that this utility may be applicable to other optical elements that include a polarizer.

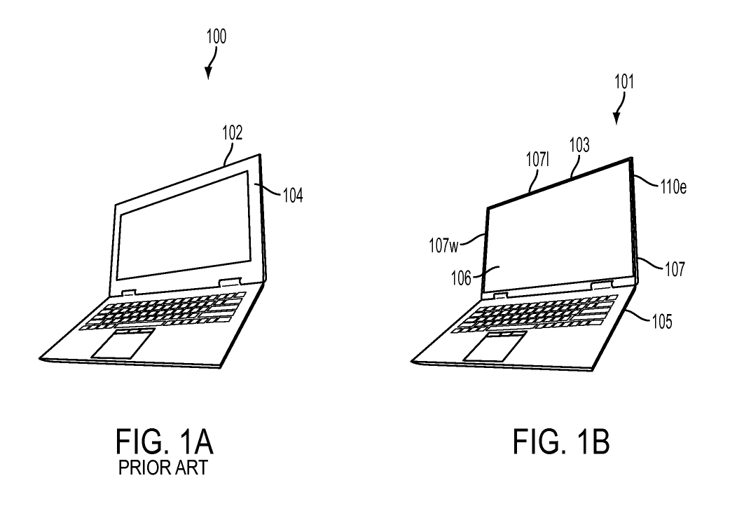

Referring now to FIG. 1B, a display device system 101 is shown according to an exemplary embodiment of the present invention. In an exemplary embodiment, the display device system 101 may be a laptop with a display device 103 and a computing device 105. The display device 103 and the computing device 105 may be coupled together within a housing 107. The display device 103 may be in operable connection with the computing device 105. For example, images shown within a display area 106 may be controlled by the computing device 105. The laptop computer may be one of the ThinkPad® series of personal computers sold by Lenovo (US) Inc. of Morrisville, N.C., or a workstation computer, such as the ThinkStation®, which is sold by Lenovo (US) Inc. of Morrisville, N.C..

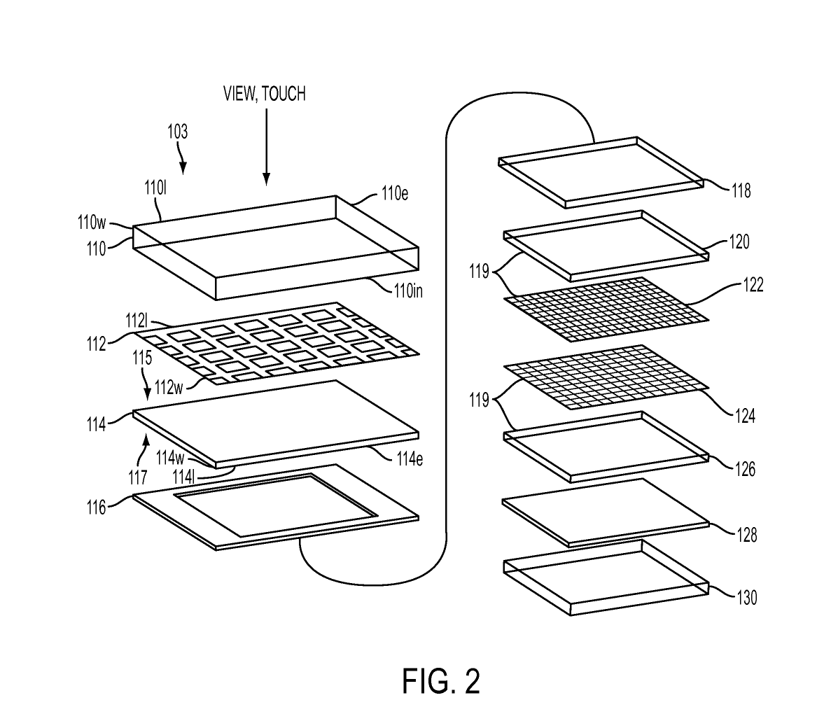

Referring now to FIGS. 1B and 2 a display device 103 is shown in exploded view according to an exemplary embodiment of the present invention. The display device 103 may use a touch-sensitive touch screen technology detecting a location of an object (e.g., a finger or a stylus) touching a screen, while the display device 103 presents images to the user, a control device (not shown) associated with the touch screen technology may correlate the location of the touch with the displayed images to understand the user's intent.

The display device 103 may include a transparent protective layer 110. The transparent protective layer 110 may be, for example glass, hard plastic, or acrylic. In some embodiments, the width 110w and length 110l of the transparent protective layer 110 may extend out to the perimeter of the housing 107. In some embodiments, edges 110e of the transparent protective layer 110 may overlay edges 107e of the housing 107.

The display device 103 may include a touch screen layer 112. The touch screen layer 112 may be a capacitive sensing layer. For example, an indium tin oxide (ITO) grid may be used. While the description of the display device 103 may be in the context of a capacitive sensing layer, other types of touch screen technologies may be used including resistive, infra-red, optical imaging, dispersive signal, or acoustical types. The touch screen layer 112 may be coupled to an interior side 110ᵢₙₜ of the transparent protective layer 110, for example, the side opposite from an exterior of the display device 103. In some embodiments, the touch screen layer 112 may include a width 112w and a length 112l that may correspond to the width 110w and length 110l.

A polarizer layer 114 may include a first side 115 attached to a side of the touch screen layer 112 that may be opposite the interior side 110ᵢₙₜ of the transparent protective layer 110. In some embodiments, the polarizer layer 114 may have diffusion properties in addition to polarization properties. The polarizer layer 114 may have a protective layer (e.g., triacetyl cellulose (TAC) film or other polymer) on its outer surface. The polarizer layer 114 may include a width 114w and length 114l that may correspond to the width 110w and length 110l. For example, polarizer layer edges 114 may extend to corresponding edges 110e of the transparent protective layer 110. In some embodiments, only one of the dimensions, for example, width 114w may be disposed aligned under corresponding width 110w. It may be appreciated that by configuring the display device 103 with a polarizer layer 114 that may extend in alignment to the edges 110w and 110l, that a seamless or uniform appearance in the display area 106 may be achieved.

A second side 117 of the polarizer layer 114 may be coupled to an electronic display unit 119. In some embodiments, the polarizer layer 114 may be disposed between the electronic display unit 119 and the transparent protective layer 110. The electronic display unit may be, for example, a liquid crystal display (LCD). The LCD may include a color filter 122 disposed between two glass substrates 120 and 126. In some embodiments using an LCD, the LCD may be a thin film type including a thin film transistor layer 124 coupled to the color filter 122. An adhesive layer 118, for example, an optical clear adhesive (OCA) or a double-sided adhesive tape may be used to attach the electronic display unit 119 to another element in the display device 103, for example, the polarizer layer 114.

The display device 103 may include a film border 116 to hide a display subsystem's trim, the display's inactive area, and/or other device components (for example, cameras, sensors, electronics) that are not a part of the active display area or should not be visible under the transparent protective layer 110. The film border 116 may be disposed between the polarizer layer 114 and the electronic display unit 119. Since the polarizer layer 114 may be disposed between the film border 116 and the transparent protective layer 110, the film border 116 may be disguised so that a user may not see the film border 116, for example, as a trim around the display 106.

A polarizer layer 128 may be positioned on a side of the electronic display unit 119 opposite the polarizer layer 114. A light source 130, for example, a backlight unit may be disposed to provide illumination to the electronic display unit 119. The polarizer layers 114 and 128 may be configured to filter transmitted light from the light source 130 so that the light passes in selected planes of polarization. The computing device 105 may control how light is passed through the polarizer layers 114 and 128 by selectively turning polarization on and off. The computing device 105 may also control how images displayed in the display area 106 may be generated by the electronic display unit 119.

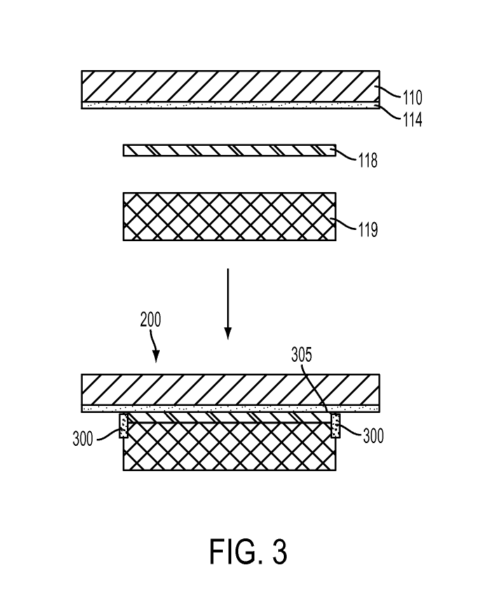

Referring now to FIG. 3, a display device 200 is shown according to another exemplary embodiment of the present invention. The display device 200 may be similar to the display device 103 except that one or more reflectors 300 may be used to control light leakage. The reflectors 300 may be disposed at an interface 305 of the polarizer layer 114 and the electronic display unit 119. For sake of illustration, some of the elements of the display device 200 have been omitted which may not necessarily be adjacent to or connected with the interface 305. The reflector 300 may baffle light leakage that may emanate from the periphery of the electronic display unit 119 out to the sides of the display device 200.

It should be understood, of course, that the foregoing relate to exemplary embodiments of the invention and that modifications may be made without departing from the spirit and scope of the invention as set forth in the following claims.

We claim:

1. A display device, comprising:
a glass layer including a first side and a second side, wherein the first side is exposed to an external side of the display device;
a capacitive sensing layer coupled to the second side of the glass layer;
a polarizer layer attached to a side of the capacitive sensing layer opposite the second side of the glass layer, wherein the polarizer layer includes a width and length that correspond to a width and length of the glass layer;
an electronic display unit coupled to the polarizer layer; and
a light source coupled to the electronic display unit.

2. The display device of claim 1, wherein the electronic display unit is a liquid crystal display (LCD).

3. The display device of claim 1, wherein the capacitive sensing layer includes a width and a length that correspond to the width and length of the glass layer.

4. The display device of claim 1 further comprising a housing wherein edges corresponding to the width and length of the glass layer overlay edges corresponding to a width and length of the housing.

5. The display device of claim 1, wherein the capacitive sensing layer is an indium tin oxide (ITO) grid.

6. The display device of claim 1 further comprising a reflector coupled to an interface between the electronic display unit and the polarizer layer.

7. The display device of claim 6, wherein the reflector is disposed to baffle light leaks between the electronic display unit and the polarizer layer.

8. A computing system, comprising:
a housing;
a computing device coupled to the housing; and
a display device in operable connection with the computing device, wherein the display device comprises:
a transparent protective layer coupled to the housing;
a polarizer layer disposed between the transparent protective layer and the housing, wherein the polarizer layer includes a width that corresponds to a width of the transparent protective layer;
an electronic display unit coupled to the polarizer layer, wherein the electronic display unit is controlled by the computing device, and
a light source coupled to the electronic display unit.

9. The computing system of claim 8 further comprising a touch screen layer between the transparent protective layer and the housing.

10. The computing system of claim 9, wherein the touch screen layer is a capacitive sensing type.

11. The computing system of claim 10, wherein the touch screen layer is an indium tin oxide (ITO) grid.

12. The computing system of claim 8, wherein the electronic display unit is a liquid crystal display (LCD).

13. The computing system of claim 8, wherein the computing device is a laptop, notebook, or tablet.

14. A liquid crystal display, comprising:
a transparent protective layer;
a color filter disposed on an interior side of the transparent protective layer, wherein the color filter is configured for control by a computing device;
a first polarizer layer disposed between the transparent protective layer and the color filter, wherein edges of the polarizer layer extend to edges of the transparent protective layer; and
a backlight source disposed to illuminate the color filter.

15. The liquid crystal display of claim 14, wherein all edges of the polarizer layer extend to corresponding edges of the transparent protective layer.

16. The liquid crystal display of claim 14 further comprising a touch screen layer between the transparent protective layer and the color filter.

17. The liquid crystal display of claim 14 further comprising a capacitive sensing layer disposed between the transparent protective layer and the color filter.

18. The liquid crystal display of claim 17, wherein the capacitive sensing layer includes a width and a length that correspond to the width and length of the transparent protective layer.

19. The liquid crystal display of claim 16 further comprising a second polarizer layer disposed between the backlight source and the color filter.

20. The liquid crystal display of claim 15 further comprising a reflector positioned at an interface of the color filter and the first polarizer layer.
